(19) United States
(12) Patent Application Publication
(10) Pub. No.: US 2010/0217536 A1
(43) Pub. Date: Aug. 26, 2010

(54) BUNKER FUEL TRANSFER

(75) Inventors: Richard P. Casimiro, North Kingstown, RI (US); Mihaela D. Duta, Crescent (GB); Manus P. Henry, Oxford (GB); Michael S. Tombs, Oxford (GB); Feibiao B. Zhou, Oxford (GB)

Correspondence Address: FISH & RICHARDSON P.C., P.O. BOX 1022, MINNEAPOLIS, MN, 55440-1022, US

(73) Assignee: Invensys Systems, Inc., Foxboro, MA (US)

(21) Appl. No.: 12/536,541

(22) Filed: Aug. 6, 2009

Related U.S. Application Data
(60) Provisional application No. 61/155,883, filed on Feb. 26, 2009.
(60) Provisional application No. 61/181,963, filed on May 28, 2009.

(51) Int. Cl. G01F 1/00; G06F 19/00

(52) U.S. Cl. 702/25; 702/45

(57) ABSTRACT

A bunker fuel transfer system that includes a multi-measurement metering system and bunkering receipt issuing equipment (BRIE). The bunker fuel transfer system can be installed on either the bunker barge or the ship receiving the bunker fuel. Various implementations can provide for quantity certainty of bunker fuel delivery transactions, and can provide for automated bunker fuel transfer reports. The bunker fuel transfer reports can include details and trends of the bunker fuel transfers to allow for quantity measurement validation. In addition, some implementations may provide for quality validation by including pertinent measurements, which can be included in the reports.

### CLAIM OF PRIORITY

This application claims priority under 35 USC §119(e) to U.S. Patent Application Ser. No. 61/155,883, filed on Feb. 26, 2009 and U.S. Patent Application Ser. No. 61/181,963, filed on May 28, 2009. The entire contents of both are incorporated by reference.

### TECHNICAL FIELD

This description relates to the transfer of bunker fuels.

### BACKGROUND

Bunker fuel generally refers to any type of fuel oil used aboard ships. Bunker fuels are delivered to commercial ships via bunker barges, which often hold the bunker fuel in large tanks. The practice of delivering bunker fuels is commonly referred to as “bunkering”, as such bunker barges can also be known as bunkering barges. The bunker fuel is typically pumped from the barge's tanks to the commercial ships. At times, bunker fuels may be transferred between bunker barges. A bunker barge owner/operator typically time charters the operation of the bunker barge to a major oil supplier, where the contracted bunker barge service is used by the oil supplier to deliver marine fuels to ships. The term “stem” is used to refer to the fuel delivered during a particular bunker delivery. For example, a ship might receive a 500 ton stem.

### SUMMARY

In one aspect, a bunker fuel transfer system includes a Coriolis flowmeter, at least one sensor, and a computing system. The Coriolis flowmeter has a flowtube with an inlet that is configured to be coupled to a first conduit that provides bunker fuel from a bunker barge and an outlet that is configured to be coupled to a second conduit that provides the bunker fuel to a receiving vessel. The Coriolis flowmeter is configured to measure a flowrate of the bunker fuel as the bunker fuel flows through the flowtube. The sensor is configured to measure a parameter of the bunker fuel as the bunker fuel flows through the flowtube. The computing system is configured to receive the measured flowrate from the Coriolis flowmeter, receive the measured parameter from the sensor, and generate a bunker transfer report based on the received flowrate and the received parameter. The bunker transfer report includes a total amount of the bunker fuel that is transferred from the bunker barge to the receiving vessel and information related to the parameter measured by the sensor.

Implementations may include one or more of the following features. The bunker transfer report may include one or more graphs displaying the measured flowrate of the bunker fuel over time and the measured parameter over time. The bunker transfer report may include one or more graphs displaying the total amount of bunker fuel transferred over time.

The Coriolis flowmeter may be configured to measure a mixture density of the bunker fuel with entrained air as the bunker fuel flows through the flowtube. The bunker transfer report may include information related to the mixture density, such as one or more graphs displaying the mixture density over time.

The Coriolis flowmeter may be configured to detect when air is entrained in the bunker fuel as the bunker fuel flows through the flowtube. The bunker transfer report may include information related to the air entrained in the bunker fuel as the bunker fuel flows through the flowtube.

The bunker transfer report may include information related to the quality of the bunker fuel as the bunker fuel flows through the flowtube. The system may include one or more of a viscometer configured to measure a viscosity of the bunker fuel as the bunker fuel flows through the flowtube, a water cut meter configured to measure a water content of the bunker fuel as the bunker fuel flows through the flowtube, or a sulphur analyzer configured to measure a sulphur content of the bunker fuel as the bunker fuel flows through the flowtube. The information related to the quality of the bunker fuel as the bunker fuel flows through the flowtube may include information related to the viscosity of the bunker fuel measured by the viscometer, information related to the water content of the bunker fuel measured by the water cut meter, or information related to the sulphur content of the bunker fuel measured by the sulphur analyzer.

The at least one sensor may include a temperature sensor and the parameter may be a temperature at the inlet of the flowtube. The at least one sensor may be a pressure sensor and the parameter may be a pressure at the inlet or outlet of the flowtube. The at least one sensor may include two pressures sensors and the parameter may be a differential pressure between the inlet and outlet of the flowtube.

The system may include multi-variable transmitter configured to transfer the measured parameter from the at least one sensor to the computing system. The computing device may be configured to display information related to the flowrate and the measured parameter on a display device.

In another aspect, an inlet of a flowtube of a Coriolis flowmeter is coupled to a first conduit that provides bunker fuel from a bunker barge. An outlet of the flowtube is coupled to a second conduit that provides the bunker fuel to a receiving vessel. A flowrate of the bunker fuel is measured using the Coriolis flowmeter as the bunker fuel flows through the flowtube. A parameter of the bunker fuel is measured using at least one sensor as the bunker fuel flows through the flowtube. A bunker transfer report is generated based on the measured flowrate and the measured parameter. The bunker transfer report includes a total amount of the bunker fuel that is transferred from the bunker barge to the receiving vessel and information related to the parameter measured by the sensor.

Implementations of this aspect may include one or more the following features.

The bunker transfer report may include one or more graphs displaying the measured flowrate of the bunker fuel over time and the measured parameter over time. The bunker transfer report may include one or more graphs displaying the total amount of bunker fuel transferred over time.

A mixture density of the bunker fuel with entrained air may be measured using the Coriolis flowmeter as the bunker fuel flows through the flowtube. The bunker transfer report may include information related to the mixture density, such as one or more graphs displaying the mixture density over time.

The Coriolis flowmeter may be used to detect when air is entrained in the bunker fuel as the bunker fuel flows through the flowtube. The bunker transfer report may include information related to the air entrained in the bunker fuel as the bunker fuel flows through the flowtube.

The bunker transfer report may include information related to the quality of the bunker fuel as the bunker fuel flows through the flowtube. A viscosity of the bunker fuel as the bunker fuel flows through the flowtube may be measured, a water content of the bunker fuel as the bunker fuel flows through the flowtube may be measured, or a sulphur content of the bunker fuel as the bunker fuel flows through the flowtube may be measured. The information related to the quality of the bunker fuel as the bunker fuel flows through the flowtube may include information related to the measured viscosity of the bunker fuel, information related to the measured water content of the bunker fuel, or information related to the measured sulphur content of the bunker fuel.

The at least one sensor may include a temperature sensor and the parameter may be a temperature at the inlet of the flowtube. The at least one sensor may be a pressure sensor and the parameter may be a pressure at the inlet or outlet of the flowtube. The at least one sensor may include two pressures sensors and the parameter may be a differential pressure between the inlet and outlet of the flowtube.

The measured parameter may be transmitted from the at least one sensor to a computing system using a multi-variable transmitter. Information related to the flowrate and the measured parameter may be displayed on a display device.

Implementations of any of the techniques described above may include a method or process, a system, or instructions stored on a storage device. The details of particular implementations are set forth in the accompanying drawings and description below. Other features will be apparent from the following description, including the drawings, and the claims.

### DESCRIPTION OF DRAWINGS

FIG. 1A is an illustration of a Coriolis flowmeter using a bent flowtube.

FIG. 1B is an illustration of a Coriolis flowmeter using a straight flowtube.

FIG. 2 is a block diagram of a Coriolis flowmeter.

FIG. 3 depicts a block diagram of an example of a multi-measurement metering system installed on a skid and a BRIE system installed in a vessel control room.

FIGS. 4 and 5 illustrate an example of a multi-measurement metering system installed on a skid.

FIG. 6 illustrates an example of the skid installed on the deck of a bunker barge.

FIG. 7 illustrates an example of a BRIE system.

FIGS. 8A and 8B illustrate an example of a simplified multi-measurement metering system.

FIGS. 9A-9C show an example of a bunker transfer report.

FIGS. 10A-10C show an example of an alternative bunker transfer report.

FIG. 11 shows an example of a bunker delivery note that may be generated by a BRIE system.

FIGS. 12-19 show examples of screens that may be displayed by a BRIE system to allow for real-time monitoring of a bunker fuel transfer.

### DETAILED DESCRIPTION

Overview

The following describes implementations of a bunker fuel transfer system that includes a multi-measurement metering system and bunkering receipt issuing equipment (BRIE). The bunker fuel transfer system can be installed on either the bunker barge or the ship receiving the bunker fuel. Various implementations can provide for quantity certainty of bunker fuel delivery transactions, and can provide for automated bunker fuel transfer reports. The bunker fuel transfer reports can include details and trends of the bunker fuel transfers to allow for quantity measurement validation. In addition, some implementations may provide for quality validation by including pertinent measurements, which can be included in the reports.

In one implementation, the multi-measurement metering system includes a Coriolis flowmeter, a temperature sensor, pressure sensors, and a multi-variable transmitter. The bunker fuel is pumped through the Coriolis flowmeter during the transfer, and the Coriolis flowmeter measures the mass flowrate of the liquid (e.g., bunker fuel), the mixture density (e.g., combined bunker fuel and air when entrained air is present or solely bunker fuel when entrained air is not present) the total mass of the transfer, and other parameters such as, for example, parameters related to the gas void fraction present in the fuel. The temperature sensor measures the fluid temperature of the bunker fuel at the inlet of the metering system. The pressure sensors sense the fluid pressure at the inlet of the metering system and the pressure drop between the inlet and the outlet of the metering system.

The Coriolis flowmeter transfers the mass flowrate, density, total mass and other measurements to the BRIE. Also, the multi-variable transmitter transmits the temperature and pressure measurements to the BRIE. The BRIE then generates a bunker report that includes the total mass transferred, as well as information regarding the other measured parameters. For example, the report can include the mass weighted averages of the mixture density, the fluid temperature, and the inlet fluid pressure throughout the transfer. The report can also include graphs of one or more of the liquid mass flowrate, the mixture density, the cumulative liquid mass flow total, the fluid temperature, the inlet fluid pressure, and the pressure drop during the transfer.

The information regarding the other measured parameters can be used to validate the reported total mass transferred by providing insight into various conditions of the bunker fuel during the transfer that affect the mass transferred. For instance, fluctuations in the mixture density result in fluctuations of the liquid mass flowrate. The mixture density may fluctuate as a result of a fluctuation in the temperature of the bunker fuel, as a result of entrained air, or a combination of both. In addition, increases in pressure increase the mass flowrate, while decreases in pressure decrease the mass flowrate. Thus, fluctuations of the mass flow rate during the transfer can be validated as legitimate fluctuations, for example, by noting corresponding fluctuations in the mixture density, temperature, and/or pressure. Including information regarding the mass flow rate, the bulk density, fluid pressure, and fluid temperature, or some combination thereof, in the report may allow a viewer of the report to understand the various conditions of the bunker fuel during transfer, which can validate the reported total mass transferred.

In addition, in various implementations, the information regarding the other measured parameters can be used to validate the quality of the bunker fuel. For instance, the fuel density at a reference density and pressure can be determined to assess whether it is within established standards. Some implementations also can include additional measurements for quality, such as a sulphur content and/or viscosity.

In various implementations, the Coriolis flowmeter also may provide an indication of when the bunker fuel contains entrained air, and the bunker transaction reports can also indicate the amount of bunker fuel during the batch that contained entrained gas. Also, in various implementations, the BRIE can provide a human-machine-interface (HMI) that shows real-time information regarding the transfer, such as the liquid mass flowrate, the mixture density, the cumulative liquid mass flow total, the fluid temperature, the fluid pressure, and the pressure drop.

Coriolis Flowmeters

Coriolis-type mass flowmeters are based on the Coriolis effect, in which material flowing through a conduit becomes a radially-travelling mass that is affected by a Coriolis force and therefore experiences an acceleration. Many Coriolis-type mass flowmeters induce a Coriolis force by sinusoidally oscillating a conduit about a pivot axis orthogonal to the length of the conduit. In such mass flowmeters, the Coriolis reaction force experienced by the traveling fluid mass is transferred to the conduit itself and is manifested as a deflection or offset of the conduit in the direction of the Coriolis force vector in the plane of rotation.

Types of flowmeters include digital Coriolis flowmeters. For example, U.S. Pat. No. 6,311,136, which is hereby incorporated by reference, discloses the use of a digital Coriolis flowmeter and related technology including signal processing and measurement techniques. Such digital flowmeters may be very precise in their measurements, with little or negligible noise, and may be capable of enabling a wide range of positive and negative gains at the driver circuitry for driving the conduit. Such digital Coriolis flowmeters are thus advantageous in a variety of settings. For example, commonly-assigned U.S. Pat. No. 6,505,519, which is incorporated by reference, discloses the use of a wide gain range, and/or the use of negative gain, to prevent stalling and to more accurately exercise control of the flowtube, even during difficult conditions such as two-phase flow (e.g., a flow containing a mixture of liquid and gas). Additionally, commonly-assigned U.S. Pat. No. 7,480,576, which is incorporated by reference, discloses various methods for processing signals representing modes of vibration of the flowtube to determine one or more properties of the fluid flowing through the flowmeter. The disclosed processing methods may be particularly useful in flowmeter applications (e.g. bunkering) using large curved mass flowtubes to compensate for the effects of frequency change.

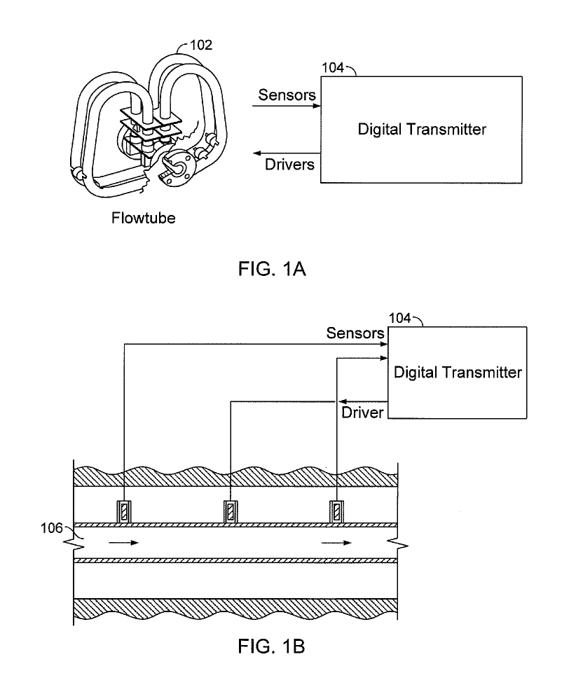

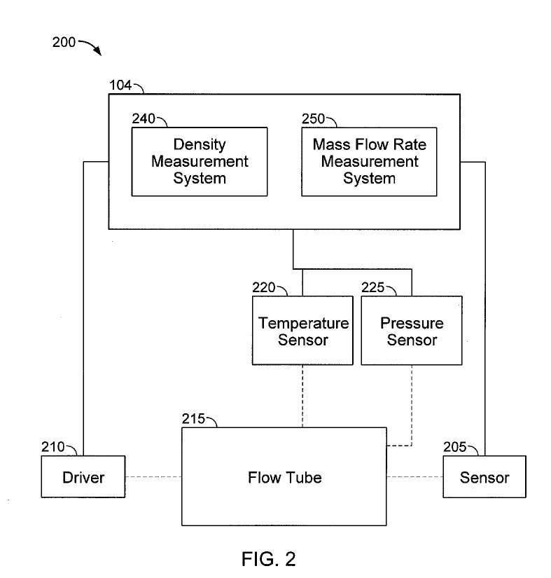

Although digital Coriolis flowmeters are specifically discussed below with respect to, for example, FIGS. 1A, 1B and 2, it should be understood that analog Coriolis flowmeters also exist. Although such analog Coriolis flowmeters may be prone to typical shortcomings of analog circuitry, e.g., low precision and high noise measurements relative to digital Coriolis flowmeters, they also may be compatible with the various techniques and implementations discussed herein. Thus, in the following discussion, the term “Coriolis flowmeter” or “Coriolis meter” is used to refer to any type of device and/or system in which the Coriolis effect is used to measure a mass flowrate, density, and/or other parameters of a material(s) moving through a flowtube or other conduit.

FIG. 1A is an illustration of a digital Coriolis flowmeter using a bent flowtube 102. Specifically, the bent flowtube 102 may be used to measure one or more physical characteristics of, for example, a (traveling or non-traveling) fluid, as referred to above. In FIG. 1A, a digital transmitter 104 exchanges sensor and drive signals with the bent flowtube 102, so as to both sense an oscillation of the bent flowtube 102, and to drive the oscillation of the bent flowtube 102 accordingly. By quickly and accurately determining the sensor and drive signals, the digital transmitter 104, as referred to above, may provide for fast and accurate operation of the bent flowtube 102. Examples of the digital transmitter 104 being used with a bent flowtube are provided in, for example, commonly-assigned U.S. Pat. No. 6,311,136.

FIG. 1B is an illustration of a digital Coriolis flowmeter using a straight flowtube 106. More specifically, in FIG. 1B, the straight flowtube 106 interacts with the digital transmitter 104. Such a straight flowtube operates similarly to the bent flowtube 102 on a conceptual level, and has various advantages/disadvantages relative to the bent flowtube 102. For example, the straight flowtube 106 may be easier to (completely) fill and empty than the bent flowtube 102, simply due to the geometry of its construction. In operation, the bent flowtube 102 may operate at a frequency of, for example, 50-110 Hz, while the straight flowtube 106 may operate at a frequency of, for example, 300-1,000 Hz. The bent flowtube 102 represents flowtubes having a variety of diameters, and may be operated in multiple orientations, such as, for example, in a vertical or horizontal orientation. The straight flowtube 106 also may have a variety of diameters, and may be operated in multiple orientations.

Referring to FIG. 2, a digital mass flowmeter 200 includes the digital transmitter 104, one or more motion sensors 205, one or more drivers 210, a flowtube 215 (which also may be referred to as a conduit, and which may represent either the bent flowtube 102, the straight flowtube 106, or some other type of flowtube), a temperature sensor 220, and a pressure sensor 225. The digital transmitter 104 may be implemented using one or more of, for example, a processor, a Digital Signal Processor (DSP), a field-programmable gate array (FPGA), an ASIC, other programmable logic or gate arrays, or programmable logic with a processor core. It should be understood that, as described in U.S. Pat. No. 6,311,136, associated digital-to-analog converters may be included for operation of the drivers 210, while analog-to-digital converters may be used to convert sensor signals from the sensors 205 for use by the digital transmitter 104.

The digital transmitter 104 may include a bulk density measurement system 240 and a bulk mass flowrate measurement system 250. Bulk properties generally refer to properties of the fluid as a whole, as opposed to the properties of a constituent component of the fluid when multi-phase flow is present (as described below). Density measurement system 240 and mass flowrate measurement system 250 may generate measurements of, respectively, density and/or mass flowrate of a material flowing through the flowtube 215 based at least on signals received from the motion sensors 205. The digital transmitter 104 also controls the drivers 210 to induce motion in the flowtube 215. This motion is sensed by the motion sensors 205.

Density measurements of the material flowing through the flowtube are related to, for example, the frequency of the motion of the flowtube 215 that is induced in the flowtube 215 (typically the resonant frequency) by a driving force supplied by the drivers 210, and/or to the temperature of the flowtube 215. Similarly, mass flow through the flowtube 215 is related to the phase and frequency of the motion of the flowtube 215, as well as to the temperature of the flowtube 215.

The temperature in the flowtube 215, which is measured using the temperature sensor 220, affects certain properties of the flowtube, such as its stiffness and dimensions. The digital transmitter 104 may compensate for these temperature effects. Also in FIG. 2, a pressure sensor 225 is in communication with the transmitter 104, and is connected to the flowtube 215 so as to be operable to sense a pressure of a material flowing through the flowtube 215.

It should be understood that both the pressure of the fluid entering the flowtube 215 and the pressure drop across relevant points on the flowtube may be indicators of certain flow conditions. Also, while external temperature sensors may be used to measure the fluid temperature, such sensors may be used in addition to an internal flowmeter sensor designed to measure a representative temperature for flowtube calibrations. Also, some flowtubes use multiple temperature sensors for the purpose of correcting measurements for an effect of differential temperature between the process fluid and the environment (e.g., a case temperature of a housing of the flowtube).

In FIG. 2, it should be understood that the various components of the digital transmitter 104 are in communication with one another, although communication links are not explicitly illustrated, for the sake of clarity. Further, it should be understood that conventional components of the digital transmitter 104 are not illustrated in FIG. 2, but are assumed to exist within, or be accessible to, the digital transmitter 104. For example, the digital transmitter 104 will typically include drive circuitry for driving the driver 210, and measurement circuitry to measure the oscillation frequency of the flowtube 215 based on sensor signals from sensors 205 and to measure the phase between the sensor signals from sensors 205.

Under certain conditions, a Coriolis flowmeter can accurately determine the bulk (mixture) density and bulk (mixture) mass flowrate of a process fluid in the flowtube 215. That is, an accurate bulk density and/or bulk mass flowrate of the process fluid can be determined under certain conditions.

Also, in some situations, the process fluid may contain more than one phase by being a mixture of two or more materials (for example, oil and water or a fluid with entrained gas), by being the same material in different phases (for example, liquid water and water vapor), or by being different materials in different phases (for example, water vapor and oil). In some multi-phase flow conditions, a Coriolis flowmeter may accurately determine the bulk density and bulk mass flowrate of the fluid, which can then be used to accurately determine the density and/or mass flowrate of the constituent phases. For example, U.S. Pat. Nos. 6,311,136; 6,505,519; and 7,059,199 describe various techniques for handling multi-phase flows, and accurately determining parameters such as the bulk density, the bulk mass flowrate, densities of the constituent phases, and the mass flowrates of the constituent phases.

Bunker Fuel Transfer System

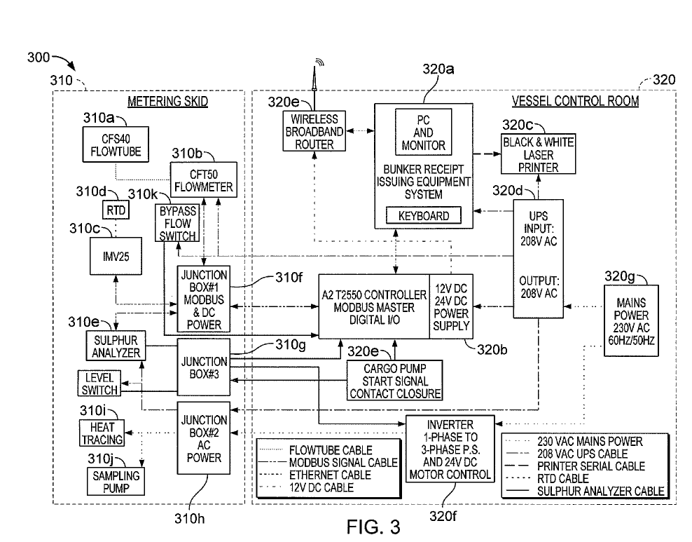

Referring to FIG. 3, one implementation of a bunker fuel transfer system 300 includes a multi-measurement metering system installed on a skid 310 and a BRIE system installed in a vessel control room 320.

The skid 310 can be configured to be installed on the deck of a bunker barge in the hazardous area. Installed on the skid 310 are a Coriolis flowtube 310a (e.g., a model CSF40 available from Invensys Process Systems of Plano, Tex.), a Coriolis transmitter 310b (e.g., a model CFT50 available from Invensys Process Systems of Plano, Tex.), a multi-variable transmitter 310c coupled to a resistance temperature detector 310d (RTD), and a sulphur analyzer 310e. The Coriolis flowtube 310a is coupled to piping that causes the bunker fluid to flow through the Coriolis flowtube 310a during transfer so that the Coriolis transmitter 310b can determine the liquid mass flowrate and the mixture density. For example, the flowtube may include an inlet that is coupled to a first conduit that provides bunker fuel from the bunker barge and an outlet that is coupled to a second conduit that provides the bunker fuel to the receiving vessel. The multi-variable transmitter 310c and RTD 310d are coupled to the piping so as to obtain fluid temperature measurements at the inlet of the skid 310, fluid pressure measurements at the inlet of the skid 310, and the fluid pressure differential between the inlet and outlet of the skid 310. The sulphur analyzer 310e is coupled to the piping so as to obtain measurements of the sulphur content of the bunker fuel. The measurements taken by the Coriolis transmitter 310b, the multi-variable transmitter 310c, and the sulphur analyzer are transmitted to the BRIE system through a Modbus and DC power junction box 310f installed on the skid 310.

Additional quantities may be calculated by the Coriolis transmitter and/or multi-variable transmitter and provided to the BRIE system. For example, the mass flow weighted averages of the fluid temperature, inlet pressure, liquid density, fluid mixture density may be calculated by the Coriolis transmitter and the multi-variable transmitter as appropriate and transmitted to the BRIE system. In one implementation, the pertinent calculations and measurements are all performed by the Coriolis transmitter and multi-variable transmitter (and other measurement devices as appropriate), with the BRIE system simply displaying some or all of these items, and generating reports that include some or all of these items. In other implementations, the BRIE system can calculate some quantities based on the readings from the Coriolis transmitter and/or the multi-variable transmitter.

The skid 310 also includes an AC power junction box 310h for AC power wiring to the Coriolis transmitter 310b and sulphur analyzer 310e. A sulphur analyzer junction box 310g is included for wiring from the sulphur analyzer to the power inverter 320f and cargo pump switch 320g. A sampling pump 310j samples the bunker fuel and provides the sample to the sulphur analyzer 310e. The heat tracing 310i ensures the bunker fuel has an acceptable viscosity for the sulphur analyzer's measurement of the sulphur content. A bypass flow switch 310k detects when a bypass valve is opened to flow bunker fuel by the skid 310 (detects when the skid 310 is and is not being used). Quick disconnect style cable terminations can be used at all junction box terminations for reduced time to install or remove the skid 310.

The BRIE system is installed in the vessel control room 320. The BRIE system includes a computer (and monitor) 320a that is programmed to present the total mass transferred (e.g., in metric tons) and other parameters based on the measurements from the Coriolis transmitter 310b, multi-variable transmitter 310c, and sulphur analyzer 310e. For example, in addition to the total mass transferred, the computer 320a may present the mass flow weighted averages of the fluid temperature, inlet pressure, liquid density, fluid mixture density (when 2-Phase flow is detected), and sulphur content % m/m.

The computer 320a is also programmed to generate bunker transfer reports including some or all of the measurements or parameters derived from them. The bunker transfer reports can include, for example, bunker fuel temperature, pressure, total mass transferred, liquid mass flow rate, and mixture density throughout each bunker fuel transaction. The computer 320a may be programmed to create and archive the bunker transfer reports in an electronic file format (e.g., portable document format (PDF)), and to provide the ability to print the reports and forward them electronically (e.g., via File Transfer Protocol (FTP)) to any designated network storage location. The transfer reports may be archived for future reference or audit purposes. Bunker delivery batch totals and bunker receipt records may be held in secure tamper proof memory.

In addition, the computer 320a may be programmed to provide an HMI for the operator. The HMI can allow an operator to initiate online monitoring of the metering system, to graphically monitor the bunker fuel delivery, to end online monitoring, and to print or forward bunker transfer reports as a record of transfers from barges to ships. The HMI can caution the operator to end the online monitoring of the metering system before the delivery hose and deck piping are drained back through metering system pipework. In some implementations, the computer 320a also may generate bunker delivery notes for barge-to-ship or barge-to-barge custody transfers, and the HMI may allow the operator to print the bunker delivery notes as a record of the custody transfer transactions of a bunker barge. In addition, the computer 320a can be programmed to display the measured and calculated variables to sufficient resolution to enable calculations to be visually verified on the monitor, and to provide alarms to monitor the health of the metering system, such as high and low flowrate limits and instrument measurement failures.

The computer 320a may be programmed to maintain cumulative batch load registers for mass, mass in air, volume and standard volume. These registers may be designed to only be reset-able under an appropriate security code. A continuous remaining on board (ROB) bunker fuel calculation can be displayed by deducting each batch load to a ship (or other barge) from the cumulative load registers. The cumulative load registers can be designed to increment during a confirmed bunker vessel loading through the metering system to bunker tanks. The cumulative load registers also can be designed to decrement at the end of a bunker fuel delivery to a ship only when the delivery hose is drained back through the metering skid to bunker storage tanks.

The computer 320a can also be programmed to take into account (for example, by using an offset or other correction) for amounts of bunker fuel needed to fill piping on the bunker barge, or left in the piping on the bunker barge after deliveries. For example, a bunker vessel may start a series of deliveries with piping fully empty. On hook-up, bunker fuel is delivered through the metering system to the receiving ship, which may necessitate filling the bunker vessel's piping, including a length of piping between the metering system and a shut-off manifold valve. For some delivery procedures, on completion and end of bunker delivery, the barge pumps are stopped, the manifold valve is closed, and the hose between bunker vessel (outboard of the manifold valve) and receiving ship is purged with compressed air. The short length of piping between the metering system outlet and the manifold valve may not be drained back to the bunker vessel's tanks after the first (and subsequent) bunker delivery and therefore this section of pipe may remain full. Consequently, on the first in a series of deliveries, the bunker fuel quantity to fill this section of pipe (and which is measured by the metering system) may not actually be delivered to the ship and therefore the metered amount may be off by the amount in this section of pipe. But deliveries subsequent to the first (with piping full up to the manifold valve) would be metered correctly. An offset or other correction can be applied, for example, to the first delivery in the situation in which the piping starts fully empty.

In addition, for example, after the last of a series of deliveries, the piping may be drained back through the metering system and, unless corrected, the actual remaining bunker fuel in the barge tanks would be greater than that calculated (for example, by deducting the cumulative bunker deliveries) by the quantity in the piping between the metering system and manifold valve. A correction can also be applied to the calculated amount in the bunker tanks in this instance to account for the bunker fuel left in the piping.

The computer 320a is coupled to a Modbus Master Controller 320b (e.g., a Controller Model T2550 Modbus Master from Invensys Process systems of Plano, Tex.) or similar programmable logic controller (PLC) to provide for communication with the Coriolis transmitter 310b, the multi-variable transmitter 310c, and the sulphur analyzer 310d through the Modbus junction box 310f.

The BRIE system can also include a printer 320c coupled to the computer to print out the bunker transfer or other reports, and an uninterruptible power supply 320d (UPS) to provide back-up power in the event the main power goes down. The UPS 320d may have a supply voltage of 208V AC at 50 to 60 Hz or other supply voltage. In the event of a power failure of the main supply voltage, the UPS 320d can be designed to provide an audible and/or a visual alarm. In the event of a sustained main supply power failure longer than a defined period of time, and before battery life of the UPS 320d is exhausted, the UPS 320d can be designed to communicate impending UPS shut down to the BRIE System to enable a safe shut down without damage to the BRIE System.

A wireless router 320e coupled to the computer 320a can provide for electronic ticketing capability by allowing for the uploading of bunkering transfer information via cellular or broadband wireless connectivity. For instance, the wireless router 320e can be used to send bunker transfer reports and bunker delivery notes to a client FTP site and can also provide clients with email notifications of bunker transfers with attached reports in electronic file format.

Other implementations may include additional measurements and associated equipment. For example, a viscometer may be included as part of the metering system to provide a measure of the bunker fuel's viscosity during the transfer. In another example, a water cut meter may be included to provide a measure of the bunker fuel's water concentration during the transfer. Such additional information can be used to further validate the quantity measurement and/or validate the quality of the bunker fuel.

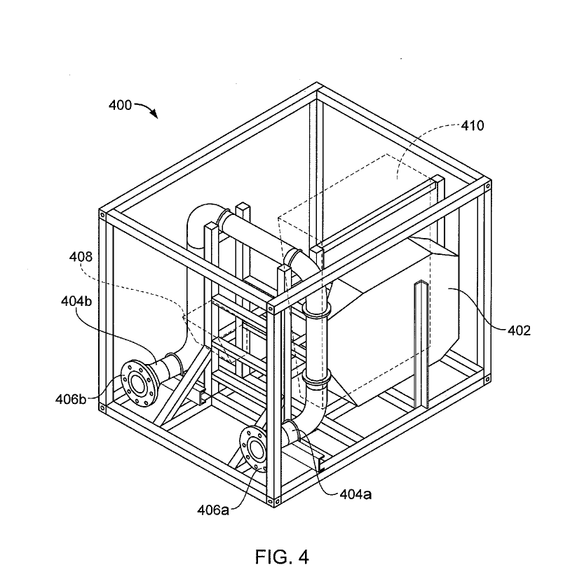

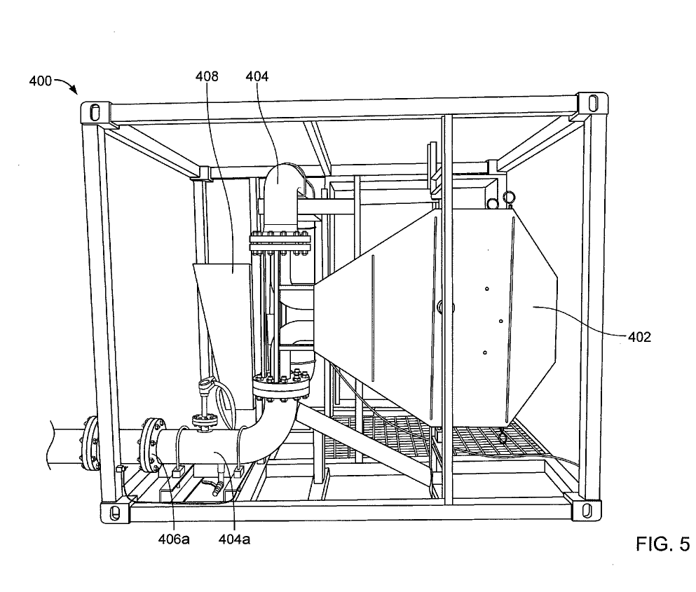

FIGS. 4 and 5 illustrate an example of a skid 400. The skid 400 can be an open frame construction that is 8 ft. high×8 ft. wide×10 ft. long and that conforms to ISO 1496-1 dimensions with DIN ISO1611 corner castings. The flowtube 402, piping 404, multi-variable transmitter, Coriolis transmitter, and junction boxes can all be installed within the skid framework and not protrude outside of the skid framework. The piping 404 coupled to the flowtube 402 may be 8″ piping. The flowtube 402 can be mounted in the vertical plane and with the inlet flow in the upward direction. The skid inlet 404a and outlet piping 404b may have 8″ PN16 flange connections 406a and 406b, respectively, or other size flange connections. A first canopy 408 may be provided to house the multi-variable transmitter and Coriolis transmitter and a second canopy 410 may be provided to house the sulphur analyzer and/or other meters. Also, bypass piping can be provided with a bypass valve to route bunker fuel from the inlet to the outlet without passing through the Coriolis flowmeter.

The skid can have a weight distribution such that the center of gravity is roughly central to the skid framework to facilitate balanced lifting and transport of the skid. The skid can be of a modular construction such that the skid can be easily installed and removed from bunker barge decks with a standardized container mounting arrangement where twist lock base fittings are secured at skid frame corners.

The 8′×8′×10′ Skid frame can be considered a half “Twenty-Foot Equivalent Unit” (TEU) container, with the possibility that two skids can be twist-locked together in tandem to form an 8′×8′×20′ container frame that can be readily lifted, stacked and container ship transported the same as a standard 20′ shipping container.

Cabling within the skid and cable extending to the vessel control room can generally be in accordance with IEC 60092 and also meet marine and local regulations for shipboard use where IEC 60092 is exceeded. The flowmeter, associated instrumentation and junction boxes can have provision for wire and lead tamper-proof seals to be fitted to all points of adjustment and connection.

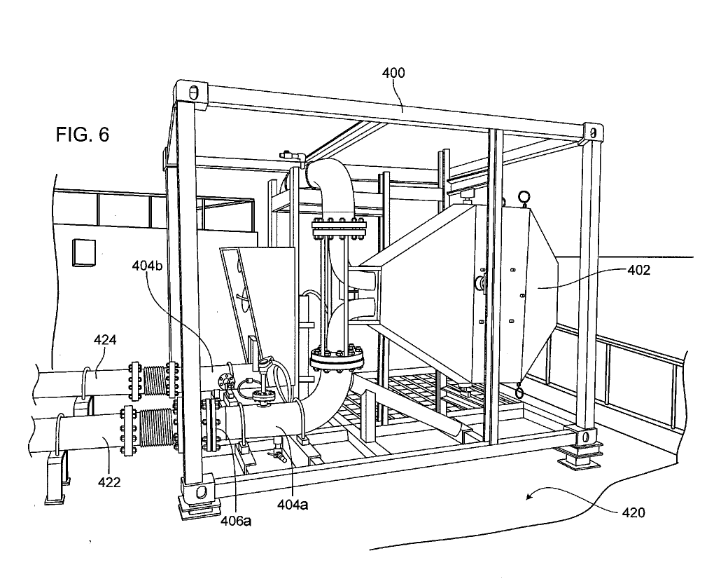

Referring to FIG. 6, the skid 400 is installed on the deck 420 of a bunker barge. The skid inlet piping 404a is coupled to a first conduit 422 via the flange connection 406a. The first conduit provides bunker fuel from the bunker barge. The skid outlet piping 404b is coupled to a second conduit 424 via the flange connection 406b. The second conduit 424 is configured to provide the bunker fuel to the receiving vessel. During a delivery, the bunker fuel flows through the first conduit 422, into the skid inlet piping 404a, through the flowtube 402, out the outlet piping 404b, and through the second conduit 424 to the receiving vessel.

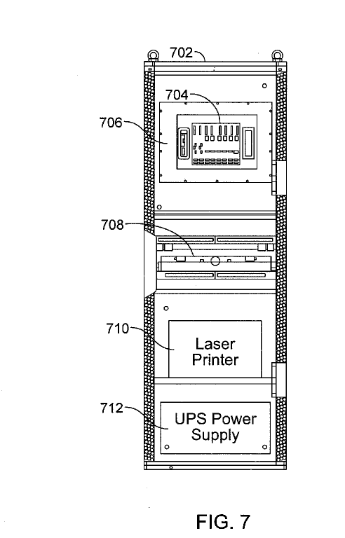

Referring to FIG. 7, an example of the BRIE system 700 includes an industrial enclosure 702, such as a rack mounting cabinet (e.g., a 19″ cabinet). The cabinet 702 can contain some or all of the components of the BRIE system 700, such as the Modbus controller 704, the computer and monitor 706, a keyboard and mouse 708 for interacting with the computer, the laser printer 710, and the UPS 712.

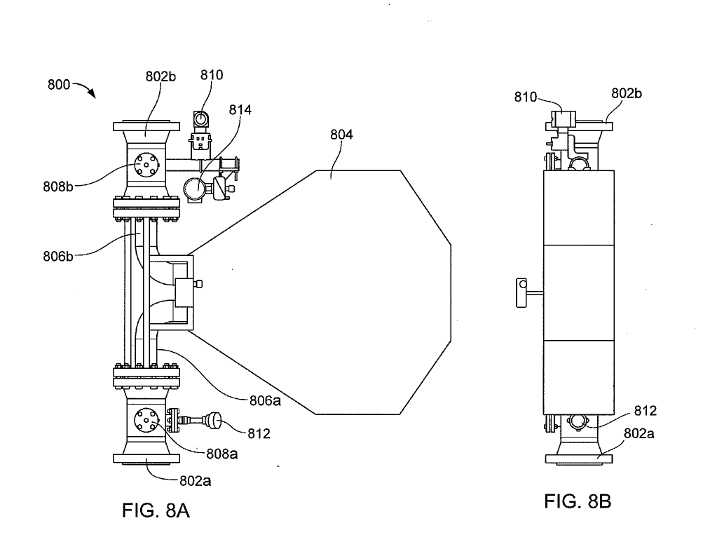

Referring to FIGS. 8A and 8B, instead of on a skid, a simplified multi-measurement metering system 800 can be implemented. For instance, flanged piping spool pieces (e.g., Class 300 weld neck flanged piping spool pieces) 802a and 802b can be coupled to the inlet 806a and outlet 806b of the Coriolis flowtube 804, and provide for close coupled mounting of the multi-variable transmitter 810 (including pressure seals 808a and 808b), the resistance temperature detector (RTD) 812, and Coriolis transmitter 814 directly to the flowtube inlet and outlet flanges. For instance, the high pressure seal 808a for the multi-variable transmitter 810 and the RTD 812 can be mounted on the inlet piping spool piece 802a. The low pressure seal 808b for the multi-variable transmitter 810, the multi-variable transmitter 810, and the Coriolis transmitter 814 can be mounted on the outlet piping spool piece 802b. This simplified multi-measurement metering system arrangement 800 may be well suited for ship mounting either below or above deck, and may take up much less space than the modular skid arrangement, which can be better suited for bunker barges. The flowtube 804 can be mounted in the vertical plane and with the inlet flow in the upward direction, or in various mounting planes for inlet flow in various other directions. In the implementation shown the sulphur meter is not used, but a sulphur meter or other instruments (for example viscometer or water cut meter) can be used in the near vicinity of the metering system to monitor fuel quality.

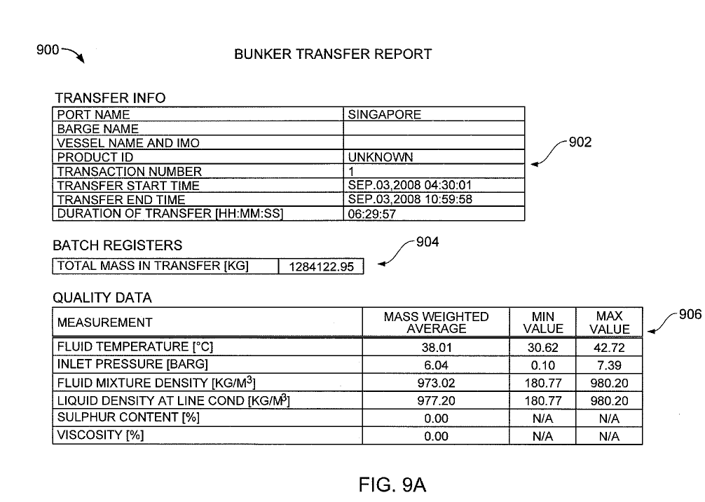

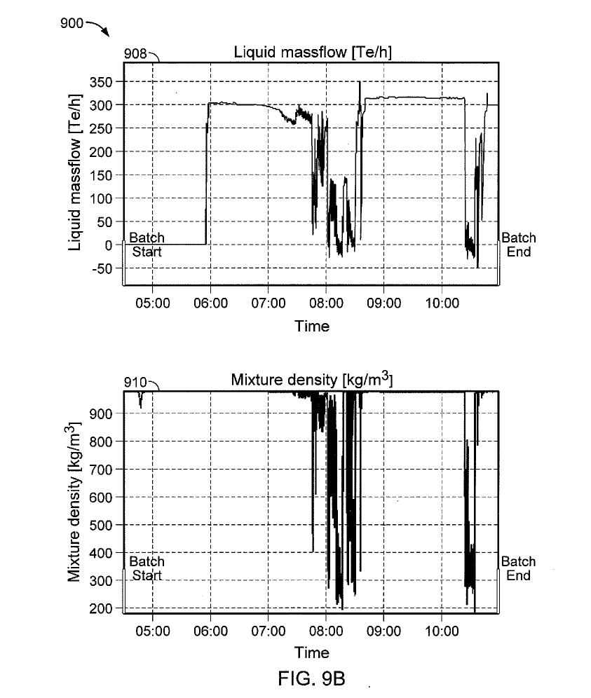

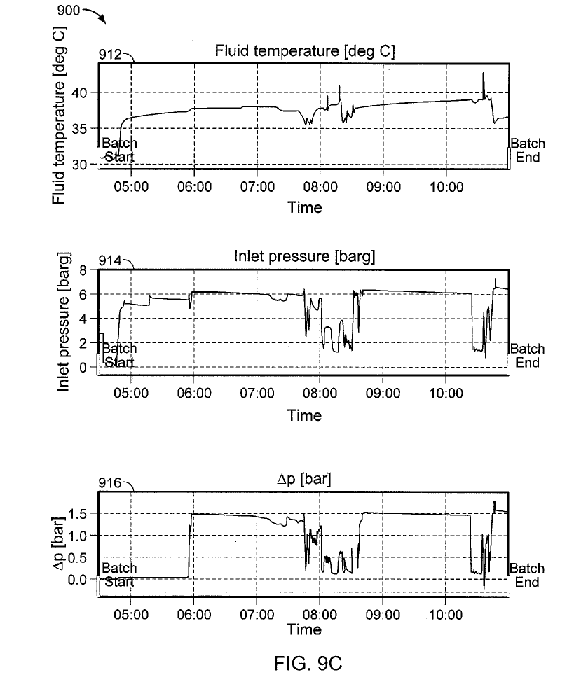

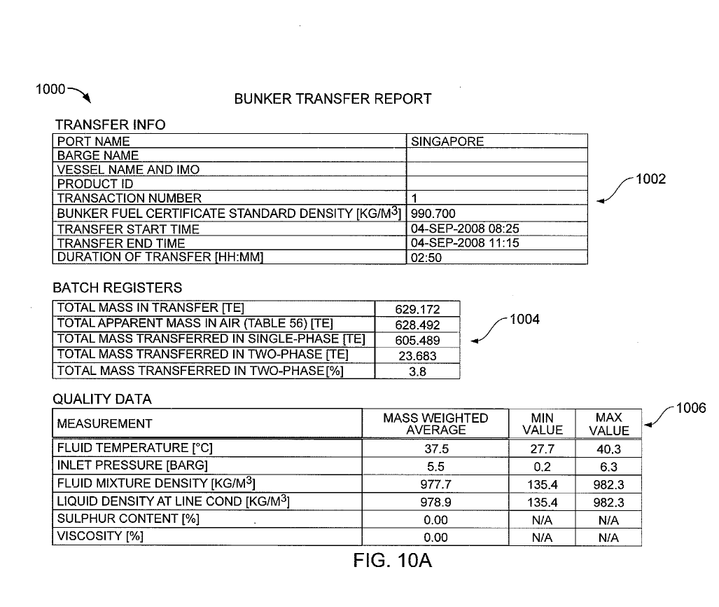

FIGS. 9A-9C show an example of a bunker transfer report 900. Referring to FIG. 9A, a summary section of the report 900 includes a first table 902, a second table 904, and a third table 906. The first table 902 includes information about the transfer, such as the port name, the barge name, the vessel name, the product id, the transaction number, the transfer start time, the transfer end time, and the duration of the transfer. The second table 904 includes the total mass transferred. The third table 906 includes some quality information, such as the mass weight average, the minimum value, and the maximum value of the fluid temperature, inlet pressure, mixture density, liquid density at line conditions, sulphur content (if a sulphur analyzer is included as part of the metering system), and viscosity (if a viscometer is included as part of the metering system).

Referring to FIGS. 9B and 9C, the rest of the report 900 includes graphs showing various conditions during the transfer. A liquid massflow graph 908 shows the liquid mass flowrate measured by the Coriolis flowmeter during the transfer. A mixture density graph 910 shows the mixture density measured by the Coriolis flowmeter during the transfer. A fluid temperature graph 912 shows the fluid temperature measured by the RTD and multi-variable transmitter during the transfer. An inlet pressure graph 914 and a differential pressure graph 916 show the pressures measured by the multi-variable transmitter and pressure sensors during the transfer.

With continued reference to FIGS. 9B and 9C, the graphs show mid way through the bunker transfer (beginning around 7:30 and lasting until about 8:45) an extended period of a two-phase (with entrained air) flow condition that the Coriolis flowmeter has detected, validating the significant effects on the real-time liquid mass flow and mixture density measurements during two-phase (with entrained air) flowing conditions. Also apparent is the tank stripping process noted at the end of the bunker transfer (starting around 10:30) where the bunker barge tank is pumped dry and air becomes pumped into the remaining bunker fuel that is pumped from the bottom of the bunker barge tank. The fluid temperature graph 912 also shows the varying bunker fuel temperature during the bunker transfer, confirming the increasing trend of the liquid mass flow rate shown in the liquid mass flow graph 908 during the latter part of the bunker transfer where the measured temperature is increasing.

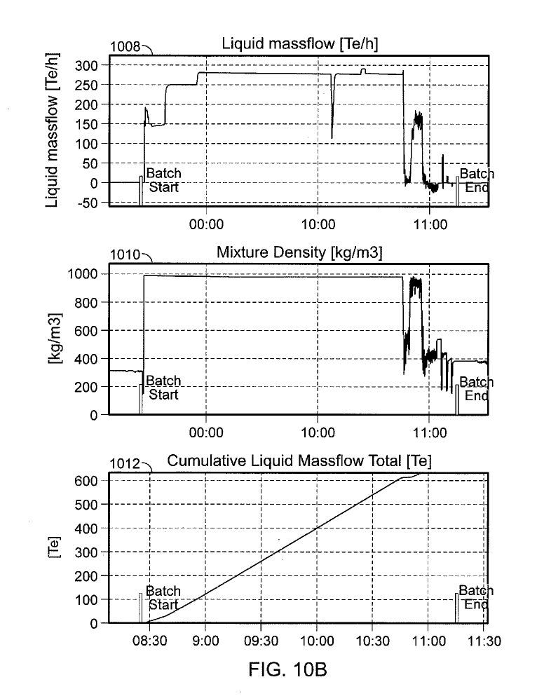

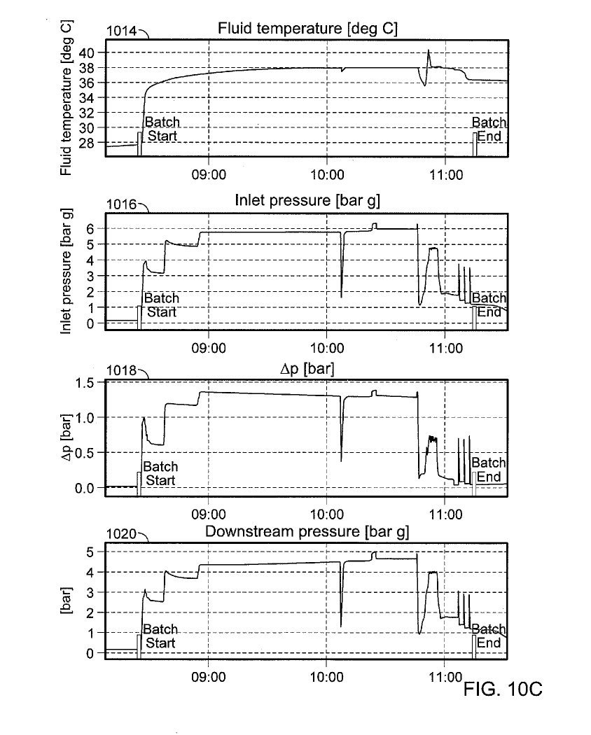

FIGS. 10A-10C show an example of an alternative bunker transfer report 1000. Referring to FIG. 10A, similar to the report 900, the report 1000 includes a summary page that includes a first table 1002, a second table 1004, and a third table 1006. The first table 1002 and the third table 1006 in the report 1000 include the same information as the first table 902 and the third table 906 in the report 900. The second table 1004 in the report 1000 includes the total mass transferred and the total apparent mass in air (as defined in ASTM D1250 IP200 Petroleum Measurement Table 56, Weight in Air correction factors). In addition, the second table 1004 in the report 1000 also includes information related to entrained air in the bunker fuel, such as the total mass transferred in single phase (without entrained air) in terms of mass (metric tons), the total mass transferred in two-phase (with entrained air) in terms of mass (metric tons), and the total mass transferred in two-phase (with entrained air) as a percentage of the total mass transferred.

Referring to FIGS. 10B and 10C, the report 1000 also includes a liquid massflow graph 1008, a mixture density graph 1010, a fluid temperature graph 1014, an inlet pressure graph 1016, and a differential pressure graph 1018. However, in addition to these graphs, the report 1000 also includes a cumulative liquid massflow total graph 1012 and a downstream pressure graph 1020. The cumulative liquid massflow total graph 1012 shows the total mass transferred over the course of the transfer, as calculated by the BRIE system from the mass flowrate measurements obtained from the Coriolis flowmeter. The downstream pressure graph 1020 shows the pressure at the outlet of the metering system as measured by the pressure sensors and the multi-variable transmitter during the transfer.

With continued reference to FIGS. 10B and 10C, the graphs show later in the bunker transfer (around 10:15) where the bunker barge pumping was switched from one bunker fuel tank to another bunker fuel tank with an intermittent drop in the mass flow rate as shown in the liquid mass flow graph 1008. Also apparent is the tank stripping process noted at the end of the bunker transfer (around 10:45) where the bunker barge tank is pumped dry and air becomes pumped into the remaining bunker fuel that is pumped from the bottom of the bunker barge tank. The cumulative liquid mass flow total graph 1012 shows the progress during the bunker fuel transfer and time to complete the bunker fuel transfer to achieve the receiving ship's ordered mass of bunker fuel to be delivered.

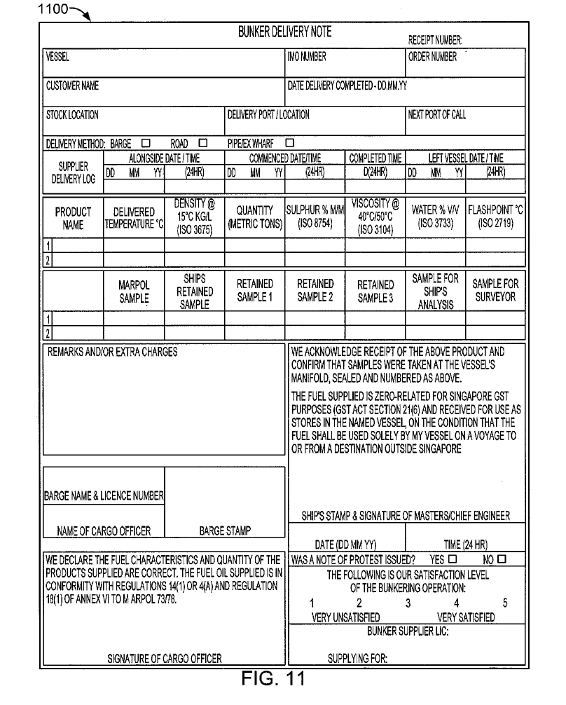

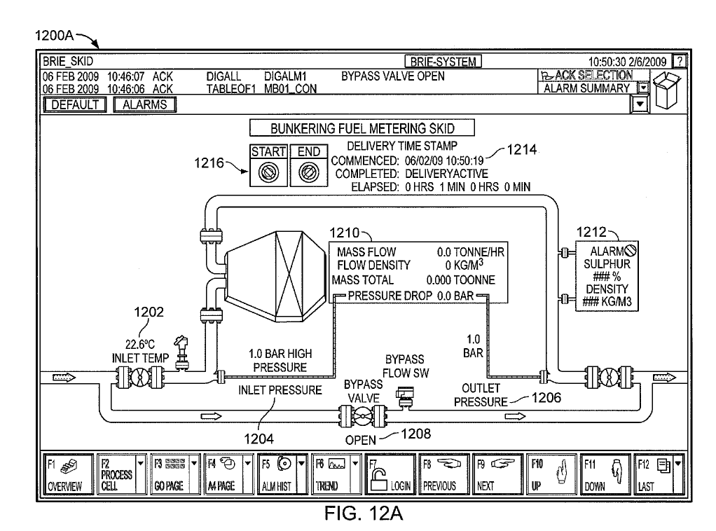

FIG. 11 shows an example of a bunker delivery note that may be generated by the BRIE system. As described above, in addition to metering transfers from a bunker barge to a ship, the bunker fuel transfer system also may be used to meter transfer of bunker fuel between barges. Bunker delivery notes are typical for such transfers, and the BRIE system may automatically generate such a bunker delivery note (with the appropriate information included in the note for the transfer).

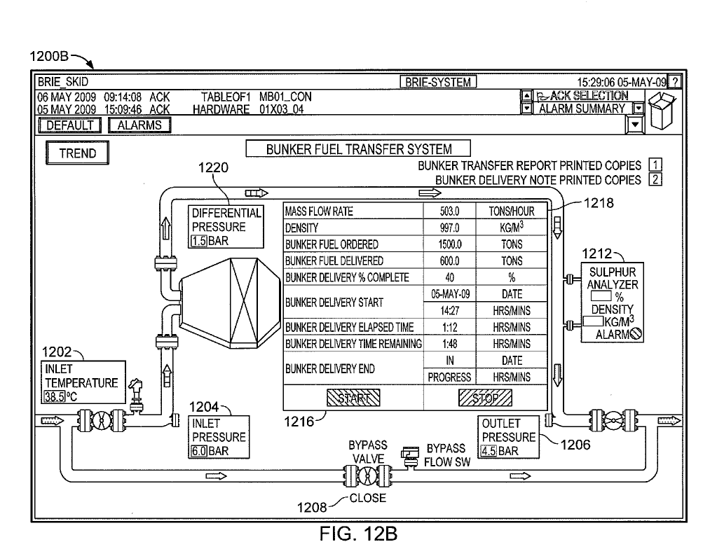

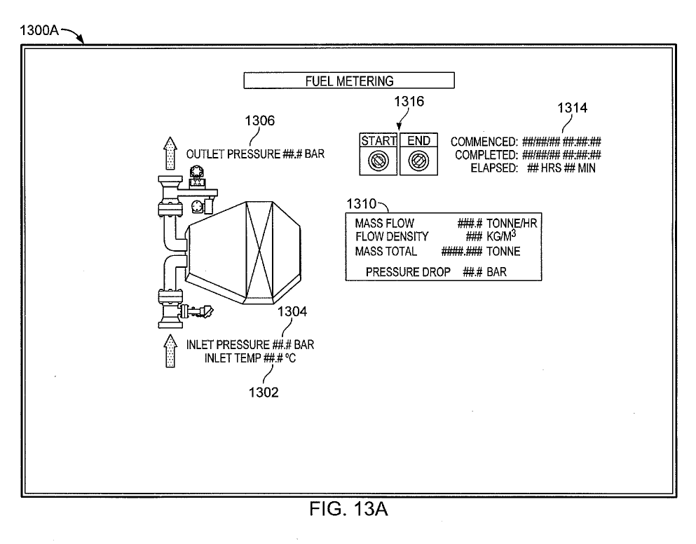

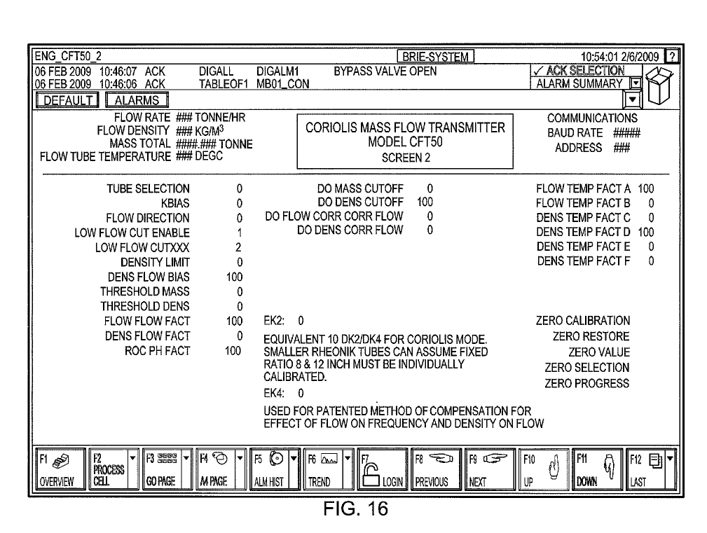

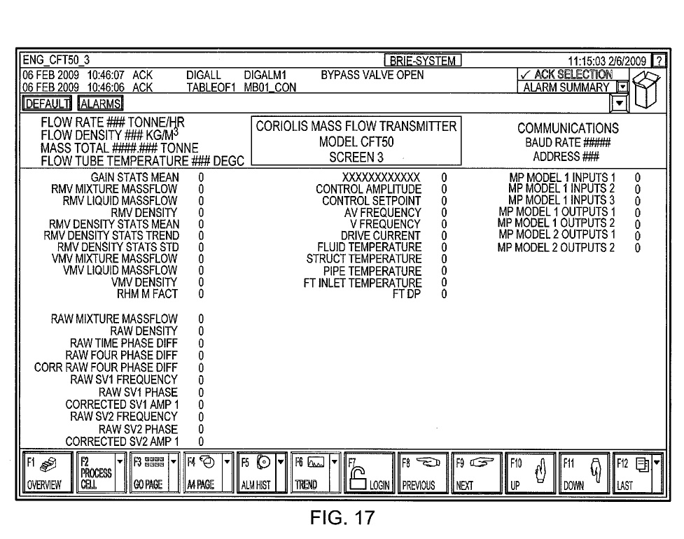

FIGS. 12-19 show examples of screens that may be displayed by the BRIE system to allow for real-time monitoring of the bunker fuel transfer. FIG. 12A shows an example of a screen 1200A that allows the various parameters measured by the multi-measurement metering skid system to be monitored. For example, screen 1200A displays the inlet temperature 1202, the inlet pressure 1204, and the outlet pressure 1206. The screen 1200A also includes an icon 1208 that shows whether the bypass valve is open or closed (with arrows showing the flow of fluid through the bypass piping when the bypass valve is open or through the flowtube when the bypass valve is closed). The parameters measured by the flowmeter (for example, the mass flow, the density, and the total mass transferred) are also displayed on the screen 1200A in graphic 1210. The graphic 1210 also shows the pressure drop between the inlet and the outlet. An icon 1212 on the screen 1200A also displays the sulphur content. In addition, the screen 1200A includes information 1214 about the particularly deliver, such as the time the delivery commenced, when the delivery was completed (or if it is currently active), and the elapsed time since the beginning of the delivery. The icons 1216 allow the operator to start and stop the bunker fuel transfer online metering of the delivery.

FIG. 12B shows another example of a screen 1200B that allows the various parameters measured by the multi-measurement metering skid system to be monitored. In addition to the information shown in the screen 1200A, the screen 1200B includes additional information regarding the transfer, such as the amount ordered, the percentage of the delivery that is complete, and the estimated time remaining for the delivery. This information is shown in graphic 1218 with the mass flowrate, the density, the deliver start time and date, the elapsed time since the beginning of the delivery, the time and date of the delivery end when it occurs, and the icons 1216 for starting and stopping the bunker fuel transfer online metering of the delivery. The differential pressure is shown by graphic 1220.

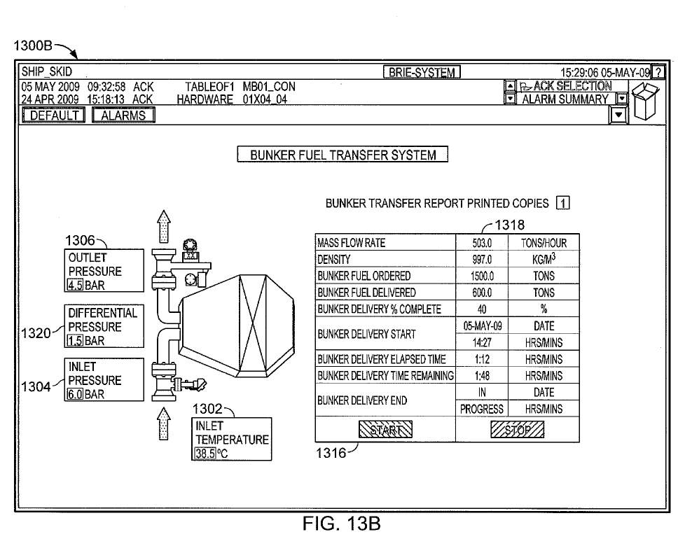

FIG. 13A shows an example of an operator interface screen 1300A where various parameters measured by the simplified metering system can be monitored and where the operator can also initiate the start of and the end of the online monitoring of the bunker fuel transfer with a simplified multi-measurement metering and BRIE system. Similar to screen 1200A, screen 1300A includes the inlet temperature 1302, the inlet pressure 1304, and the outlet pressure 1306. Screen 1300A also includes a graphic 1310 that shows the mass flowrate, the density, the total mass delivered, and the pressure drop between the inlet and outlet. In addition, the screen 1300A includes information 1314 about the particularly deliver, such as the time the delivery commenced, when the delivery was completed (or if it is currently active), and the elapsed time since the beginning of the delivery. Icons 1316 can be used by the operator to start and stop the bunker fuel transfer online metering of the delivery.

FIG. 13B shows another example of an operator interface screen 1300B where various parameters measured by the metering system can be monitored and where the operator can also initiate the start of and the end of the online monitoring of the bunker fuel transfer with a simplified multi-measurement metering and BRIE system. In addition to the information shown in the screen 1300A, the screen 1300B includes additional information regarding the transfer, such as the amount ordered, the percentage of the delivery that is complete, and the estimated time remaining for the delivery. This information is shown in graphic 1318 with the mass flowrate, the density, the deliver start time and date, the elapsed time since the beginning of the delivery, the time and date of the delivery end when it occurs, and the icons 1316 for starting and stopping the bunker fuel transfer online metering of the delivery. The differential pressure is shown by graphic 1320.

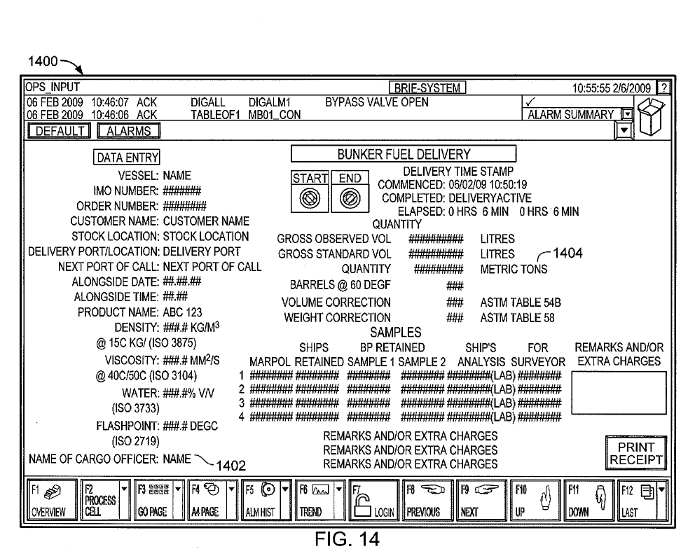

FIG. 14 shows an example of an operator interface screen where the operator would enter various details of the bunker transaction such as receiving ship name, grade of bunker fuel, cargo officer, etc. This information is reflected in area 1402. Information about the quantity delivered is shown in an area 1404. Icon 1406 can be used by the operator to start and stop the bunker fuel transfer online metering of the delivery.

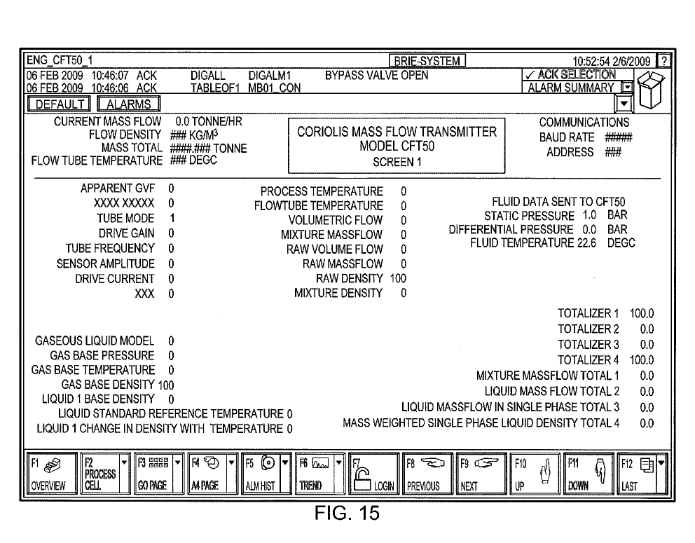

FIGS. 15-17 show examples of screens that display various parameters related to the Coriolis flowmeter so that the Coriolis flowmeter's performance can be monitored during the transfer.

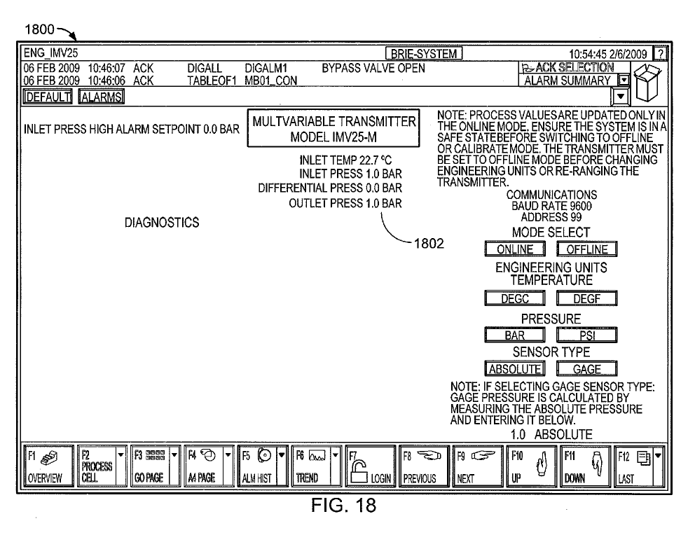

FIG. 18 shows an example of a screen 1800 that displays various parameters of the multi-variable transmitter, including measurements 1802 made by the multi-variable transmitter, so that the multi-variable transmitter's performance can be monitored during the transfer.

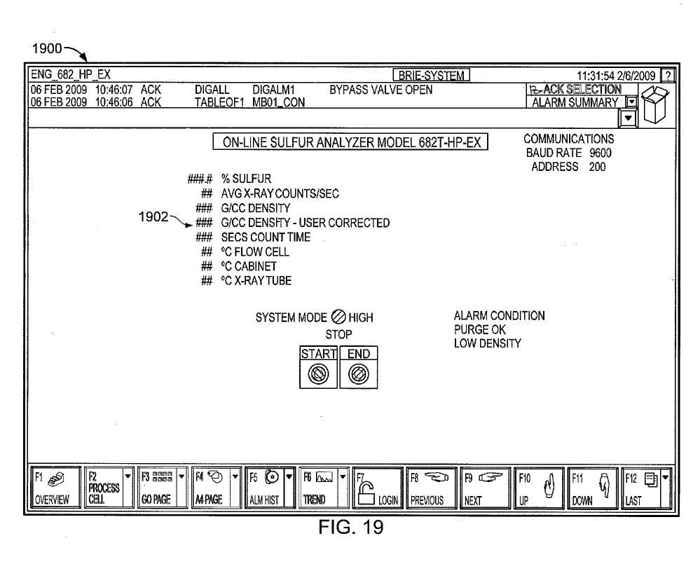

FIG. 19 shows an example of a screen 1900 that displays various parameters of the sulphur analyzer, including measurements 1902 made by sulphur analyzer, so that the sulphur analyzer's performance can be monitored during the transfer. While not shown, other screens may be provided, for example, if other measurement devices are additionally included, such as a viscometer or water cut meter.

Various implementations may be designed in compliance with a range of national and international standards and environmental conditions.

Various implementations can provide one or more of the following advantages. For instance, implementations may provide highly accurate digital flow measurement of bunker fuel transfers with real-time monitoring of temperature, pressure, density and flow rate parameters. Implementations may detect air entrainment and compensate to measure net mass of the actual bunker fuel delivered and/or provide continuous measurements and data logging throughout bunker delivery. Implementations may provide accurate measurement of delivery quantity and provide other indicators of quality. Implementations may provide electronic bunker transfer reports with graphs and trends of temperature, pressure, density and flow rate variations throughout each bunker fuel transfer that can be used in support of bunker delivery notes to provide an ‘irrefutable’ bunker delivery note or other receipt, thereby minimizing discrepancies and disputes of bunker delivery transactions. Such reports also may provide insight into bunker barge fuel transfer process variability to reduce tank-stripping practices or other fraudulent or negligent practices. Such reports may further provide accurate and robust records of bunker deliveries (electronic audit trail), and provide for rapid collation, logging, transmission and presentation of bunker delivery data in an electronic format.

What is claimed is:

1. A bunker fuel transfer system comprising:
a Coriolis flowmeter having a flowtube, the flowtube having an inlet that is configured to be coupled to a first conduit that provides bunker fuel from a bunker barge and an outlet that is configured to be coupled to a second conduit that provides the bunker fuel to a receiving vessel, wherein the Coriolis flowmeter is configured to measure a flowrate of the bunker fuel as the bunker fuel flows through the flowtube;
at least one sensor configured to measure a parameter of the bunker fuel as the bunker fuel flows through the flowtube; and
a computing system configured to receive the measured flowrate from the Coriolis flowmeter, receive the measured parameter from the sensor, and generate a bunker transfer report based on the received flowrate and the received parameter, the bunker transfer report including a total amount of the bunker fuel that is transferred from the bunker barge to the receiving vessel and information related to the parameter measured by the sensor.

2. The system of claim 1 wherein the bunker transfer report includes one or more graphs displaying the measured flowrate of the bunker fuel over time and the measured parameter over time.

3. The system of claim 1 wherein the Coriolis flowmeter is configured to measure a mixture density of the bunker fuel with entrained air as the bunker fuel flows through the flowtube.

4 The system of claim 3 wherein the bunker transfer report includes information related to the mixture density.

5. The system of claim 4 wherein the bunker transfer report includes one or more graphs displaying the mixture density over time.

6. The system of claim 1 wherein the Coriolis flowmeter is configured to detect when air is entrained in the bunker fuel as the bunker fuel flows through the flowtube.

7. The system of claim 6 wherein the bunker transfer report includes information related to the air entrained in the bunker fuel as the bunker fuel flows through the flowtube.

8. The system of claim 1 wherein the bunker transfer report includes one or more graphs displaying the total amount of bunker fuel transferred over time.

9. The system of claim 1 wherein the at least one sensor comprises a temperature sensor and the parameter comprises a temperature at the inlet of the flowtube.

10. The system of claim 1 wherein the at least one sensor comprises a pressure sensor and the parameter comprises a pressure at the inlet or outlet of the flowtube.

11. The system of claim 1 wherein the at least one sensor comprises two pressures sensors and the parameter comprises a differential pressure between the inlet and outlet of the flowtube.

12. The system of claim 1 wherein the bunker transfer report includes information related to the quality of the bunker fuel as the bunker fuel flows through the flowtube.

13. The system of claim 12 further comprising one or more of a viscometer configured to measure a viscosity of the bunker fuel as the bunker fuel flows through the flowtube, a water cut meter configured to measure a water content of the bunker fuel as the bunker fuel flows through the flowtube, or a sulphur analyzer configured to measure a sulphur content of the bunker fuel as the bunker fuel flows through the flowtube.

14. The system of claim 13 wherein the information related to the quality of the bunker fuel as the bunker fuel flows through the flowtube comprises information related to the viscosity of the bunker fuel measured by the viscometer, information related to the water content of the bunker fuel measured by the water cut meter, or information related to the sulphur content of the bunker fuel measured by the sulphur analyzer.

15. The system of claim 1 further comprising a multi-variable transmitter configured to transfer the measured parameter from the at least one sensor to the computing system.

16. The system of claim 1 wherein the computing device is configured to display information related to the flowrate and the measured parameter on a display device.

17. A method comprising:
coupling an inlet of a flowtube of a Coriolis flowmeter to a first conduit that provides bunker fuel from a bunker barge;
coupling an outlet of the flowtube to a second conduit that provides the bunker fuel to a receiving vessel;
measuring a flowrate of the bunker fuel using the Coriolis flowmeter as the bunker fuel flows through the flowtube;
measuring a parameter of the bunker fuel using at least one sensor as the bunker fuel flows through the flowtube; and
generating a bunker transfer report based on the measured flowrate and the measured parameter, the bunker transfer report including a total amount of the bunker fuel that is transferred from the bunker barge to the receiving vessel and information related to the parameter measured by the sensor.

18. The method of claim 17 wherein the bunker transfer report includes one or more graphs displaying the measured flowrate of the bunker fuel over time and the measured parameter over time.

19. The method of claim 17 further comprising measuring, using the Coriolis flowmeter, a mixture density of the bunker fuel with entrained air as the bunker fuel flows through the flowtube.

20. The method of claim 19 wherein the bunker transfer report includes information related to the mixture density.

21. The method of claim 20 wherein the bunker transfer report includes one or more graphs displaying the mixture density over time.

22. The method of claim 17 further comprising detecting, using the Coriolis flowmeter, when air is entrained in the bunker fuel as the bunker fuel flows through the flowtube.

23. The method of claim 22 wherein the bunker transfer report includes information related to the air entrained in the bunker fuel as the bunker fuel flows through the flowtube.

24. The method of claim 17 wherein the bunker transfer report includes one or more graphs displaying the total amount of bunker fuel transferred over time.

25. The method of claim 17 wherein the at least one sensor comprises a temperature sensor and the parameter comprises a temperature at the inlet of the flowtube.

26. The method of claim 17 wherein the at least one sensor comprises a pressure sensor and the parameter comprises a pressure at the inlet or outlet of the flowtube.

27. The method of claim 17 wherein the at least one sensor comprises two pressures sensors and the parameter comprises a differential pressure between the inlet and outlet of the flowtube.

28. The method of claim 17 wherein the bunker transfer report includes information related to the quality of the bunker fuel as the bunker fuel flows through the flowtube.

29. The method of claim 28 further comprising measuring a viscosity of the bunker fuel as the bunker fuel flows through the flowtube, measuring a water content of the bunker fuel as the bunker fuel flows through the flowtube, or measuring a sulphur content of the bunker fuel as the bunker fuel flows through the flowtube.

30. The system of claim 29 wherein the information related to the quality of the bunker fuel as the bunker fuel flows through the flowtube comprises information related to the measured viscosity of the bunker fuel, information related to the measured water content of the bunker fuel, or information related to the measured sulphur content of the bunker fuel.

31. The method of claim 17 further comprising transmitting the measured parameter from the at least one sensor to a computing system using a multi-variable transmitter.

32. The method of claim 17 further comprising displaying information related to the flowrate and the measured parameter on a display device.
